(19) United States
(12) Patent Application Publication
(10) Pub. No.: US 2011/0170729 A1
(43) Pub. Date: Jul. 14, 2011

(54) MICROPHONE

(76) Inventor: Jae-Myoung JHUNG, Yongin-city (KR)

(21) Appl. No.: 12/982,282

(22) Filed: Dec. 30, 2010

(30) Foreign Application Priority Data
Jan. 14, 2010 (KR) 10-2010-0003631

(51) Int. Cl. H04R 11/04

(52) U.S. Cl. 381/369

(57) ABSTRACT

A microphone is disclosed. The microphone in accordance with an embodiment of the present invention includes a diaphragm, which is formed with first indentations on the surface thereof, and a back plate, which is installed near a back side of the diaphragm, electrically connected with the diaphragm and formed with second indentations corresponding to the first indentations on the surface thereof.

### CROSS-REFERENCE TO RELATED APPLICATIONS

This application claims the benefit of Korean Patent Application No. 10-2010-0003631, filed with the Korean Intellectual Property Office on Jan. 14, 2010, the disclosure of which is incorporated herein by reference in its entirety.

### BACKGROUND

1. Technical Field

The present invention is related to a microphone, and more specifically to a microphone to which a MEMS technology is applied.

2. Background Art

Generally, audio equipment uses electrodes to vibrate a diaphragm and generate a sound, and has made advancement in step with the recent technological development.

The audio equipment is used in various applications, such as a mobile device and hearing aid, and has become smaller as the devices in which the audio equipment is implemented are becoming increasingly smaller. Moreover, microphones that are implemented with the semiconductor technology of MEMS (Micro Electro Mechanical Systems) have been recently developed and used. The MEMS technology allows for manufacturing of a small mechanical component on the surface of a silicon wafer.

FIG. 1 is a sectional view of a conventional microphone.

A microphone 10 is usually a capacitance type, and as illustrated in FIG. 1, the microphone 10 includes a diaphragm 20 and a back plate 30 that is located behind the diaphragm 20.

In an example, the diaphragm 20 and the back plate 30 are installed to be separated by a predetermined distance, and electrodes 22, 32 are connected the diaphragm 20 and the back plate 30, respectively.

Once the diaphragm 20 and the back plate 30 are installed and the diaphragm 20 is vibrated by a sound wave, an electric charge generated between the diaphragm 20 and the back plate 30 causes a change in capacitance and an electric signal according to the change in capacitance.

However, in this microphone 10, surfaces that face each other are made flat, and accordingly it is limited to increase the sensitivity and decrease the size of the microphone 10.

### SUMMARY

The present invention provides a microphone of which the structure is improved in such a way that the area of facing surfaces between the diaphragm and the back plate is increased and the mobility of the diaphragm is improved.

An aspect of the present invention features a microphone that includes: a diaphragm formed with first indentations on a surface thereof; and a back plate formed with second indentations on a surface thereof; the second indentations facing the first indentations, the back plate being installed near a back side of the diaphragm and being electrically connected with the diaphragm.

The first indentations can include a plurality of concentric cylindrical indentations.

The first indentations can include a plurality of protruded or concaved indentations.

The sectional shape of the first indentations can include a semi-circle or a polygon of which one end is open.

### BRIEF DESCRIPTION OF THE DRAWINGS

FIG. 1 is a sectional view of a conventional microphone.

FIG. 2 is a perspective view of a microphone in accordance with an embodiment of the present invention.

FIG. 3 is a sectional view of a microphone in accordance with an embodiment of the present invention.

FIG. 4 is a perspective view of a microphone in accordance with another embodiment of the present invention.

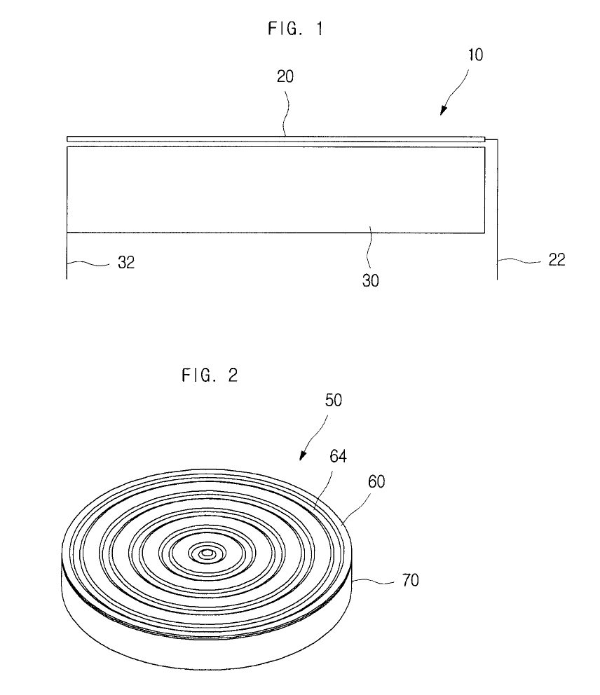

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain known technology in detail is determined to evade the point of the present invention, the pertinent detailed description will be omitted.

Hereinafter, certain embodiments of a microphone in accordance with the present invention will be described with reference to the accompanying drawings. In describing the embodiments of microphone with reference to the accompanying drawings, any identical or corresponding elements will be given identical reference numerals and their description will not be redundantly repeated.

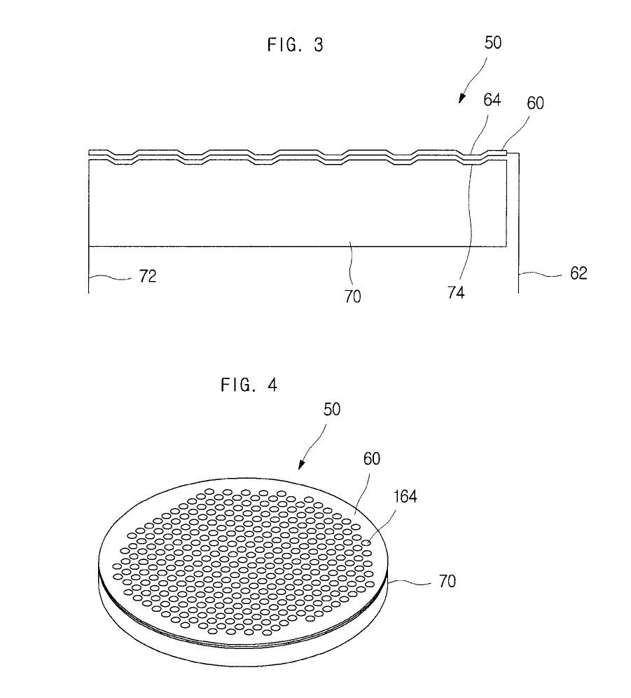

FIG. 2 is a perspective view of a microphone in accordance with an embodiment of the present invention, and FIG. 3 is a sectional view of the microphone in accordance with an embodiment of the present invention.

Referring to FIGS. 2 and 3, a microphone 50 includes a diaphragm 60 and a back plate 70.

In the microphone 50 in accordance with the present embodiment, the diaphragm 60 and the back plate 70 can be formed on a surface of a silicon wafer.

The back plate 70 is installed near the back side of the diaphragm 60. Here, the back plate 70 is installed while the back plate 70 is separated by a predetermined distance from the back side of the diaphragm 60.

A first electrode 62 is connected the diaphragm 60, and a second electrode 72, which has a different polarity from the first electrode 62, is connected to the back plate 70. For example, the diaphragm 60 can be connected by a negative (−) pole, and the back plate 70 can be connected by a positive (+) pole.

The diaphragm 60 and the back plate 70 are electrically connected and can be electrically connected to an amplifier, an AID converter and other IC components through the first electrode 62 and the second electrode 72.

Although the present embodiment is described to have separate electrodes 62, 72 respectively connected to the diaphragm 60 and the back plate 70, the present invention is not restricted to the present embodiment, and it is also possible that the diaphragm 60 and the back plate 70 function as their own respective electrode. If the diaphragm 60 is vibrated by a sound wave while certain voltage is applied between the diaphragm 60 and the back plate 70, capacitance between the diaphragm 60 and the back plate 70 can be changed, and the sound wave can be converted to an electric signal.

In the present embodiment, first indentations 64 can be formed in the diaphragm 60. The first indentations 64 improve the mobility of the diaphragm 60, and thus the sensitivity of the diaphragm 60 is improved because the diaphragm 60 can move more effectively with respect the vibrations.

In one example, the first indentations 64 can include a plurality of concentric cylindrical indentations. These cylindrical indentations can be formed by being alternately protruded toward the upper side of the surface of the diaphragm 60 or caved in toward the lower side of the surface of the diaphragm 60. Accordingly, the diaphragm 60 can be formed in a wrinkled shape.

Furthermore, second indentations 74 can be formed on an upper surface of the back plate 70. The second indentations 74 can be formed in a shape that corresponds to the shape of the first indentations 64 of the diaphragm 60.

Accordingly, the second indentations 74 formed in the back plate 70 can increase the area of surfaces that face each other between the back plate 70 and the diaphragm 60, allowing the diaphragm 60 to move more effectively and improving the sensitivity of the diaphragm 60.

In the present embodiment, a method of forming the first indentations 64 and the second indentations 74 is not restricted to any particular method. For example, the first indentations 64 and the second indentations 74 can be formed by patterning a silicon board with a photo resist and then etching the silicon board by use of XeF2 or anisotropically etching the silicon board by use of KOH.

Moreover, it is possible in the present embodiment that the diaphragm 60 or the back plate 70 is made of a material other than silicon, and it is possible that the indentations are formed by patterning the board of such material and then dry-etching or wet-etching the board.

In the present embodiment, in case the sensitivity is maintained to be the same as the conventional diaphragm, the diaphragm 60 can be made much smaller, and thus the size of the microphone 50 can be much smaller as well.

In the present embodiment, the shapes of the first indentations 64 and the second indentations that are formed in the diaphragm 60 and the back plate 70 are not restricted to any particular shape, and it is possible to modify the shapes to various shapes, such as parallel shapes or radial wrinkles, for increasing the surface areas of the diaphragm 60 and the back plate 70.

For example, FIG. 4 is a perspective view of the microphone 50 in accordance with another embodiment of the present invention, and it is possible that first indentations 164 include a plurality of protruded or concaved indentations. These protruded or concaved indentations can be formed by being alternately protruded toward the upper side of the surface of the diaphragm 60 or caved in toward the lower side of the surface of the diaphragm 60. Accordingly, the indentations 164 can be embossed on the surface of the diaphragm 60.

These protruded or concaved indentations can be formed by including semi-circular sectional shapes. Furthermore, it is possible that the sectional shapes of the protruded or concaved indentations include rectangles, trapezoids or any of other polygons. Moreover, it is possible that portions of these protruded or concaved indentations that face the surface of the diaphragm 60 are open.

Although certain embodiments of the present invention have been described, it shall be appreciated by anyone ordinarily skilled in the art to which the present invention pertains that there can be a variety of permutations and modifications of the present invention without departing from the technical ideas and scopes of the present invention that are disclosed in the claims appended below.

In addition, the microphone of the above embodiments can be used in both a sound generator that generates a sound according to the applied electric power and a sound receiver that converts, according to the electrical circuit structure, vibrations between a diaphragm and a back plate during the generation of a sound to an electric signal.

What is claimed is:

1. A microphone, comprising:
a diaphragm formed with first indentations on a surface thereof; and
a back plate formed with second indentations on a surface thereof, the second indentations facing the first indentations, the back plate being installed near a back side of the diaphragm and being electrically connected with the diaphragm.

2. The microphone of claim 1, wherein the first indentations comprise a plurality of concentric cylindrical indentations.

3. The microphone of claim 1, wherein the first indentations comprise a plurality of protruded or concaved indentations.

4. The microphone according to any of claims 1 to 3, wherein a sectional shape of the first indentations comprises a semi-circle or a polygon of which one end is open.
